(19) United States
(12) Patent Application Publication
(10) Pub. No.: US 2024/0273519 A1
(43) Pub. Date: Aug. 15, 2024

(54) COIN MANAGING UNIT, AND METHOD IN A COIN MANAGING UNIT

(71) Applicant: GIESECKE+DEVRIENT ADVANCE52 GMBH, Munchen (DE)

(72) Inventors: Klaus ALFERT, St. Augustin (DE); Lars HUPEL, Munchen (DE); Teresa RIEDL, Gmund am Tegernsee (DE)

(21) Appl. No.: 18/681,045

(22) PCT Filed: Jul. 18, 2022
(86) PCT No.: PCT/EP2022/025334

§ 371 Date: Feb. 3, 2024

(30) Foreign Application Priority Data
Aug. 4, 2021 (DE) 10 2021 004 025.2

(51) Int. Cl. G06Q 20/36

(52) U.S. Cl. CPC G06Q 20/3678

(57) ABSTRACT

A secure execution unit for managing digital coin data sets is adapted to exchange digital coin data sets with other coin managing units in transactions and transmit registration requests to a coin register; and at least one digital coin data set. The secure execution unit is additionally adapted to check a first requirement and/or a second requirement for a transaction; the first requirement and the second requirement are stored in the coin managing unit as requirement data elements; and the first requirement and the second requirement pertain to the same check criterion. The second requirement is an increase of the first requirement and/or the second requirement being checked for a different exchange direction than the first requirement.

### FIELD OF THE DISCLOSURE

The invention relates to a coin deposit managing unit with a plurality of coin deposits of different users, a method for creating new coin deposits in a coin deposit managing unit with a plurality of coin deposits and a method for managing coin data sets in a coin deposit managing unit with a plurality of coin deposits.

### BACKGROUND

Different approaches to a technical solution are already known for a digital currency issued by a central bank (CBDC).

According to a first approach, coin data sets are secured only cryptographically by a central bank entity, and the cryptographically secured coin data sets are exchanged directly between coin managing units of the users in encrypted form. The coin managing units can check the authenticity of the coin data set on the basis of its cryptographic security, such as signature, and should check in advance a certificate of the central bank and/or of the other coin managing unit for validity within the certificate hierarchy.

According to a second approach, the digital money or the coin data sets are stored in a central or decentralized blockchain of a central bank. However, if a coin data set in a blockchain changes owners within the context of a transaction, a great deal of information (sender/recipient/amount) is often published and, generally, the sender and the recipient require access to the blockchain at the time of the transaction. Since the blockchain or its server can access the electronic coin data sets, the server can independently execute a transaction, for example, at a predefined point in time.

According to a third approach, the coin data sets are stored by the user, for example in a local coin managing unit, and are exchanged directly. A coin register stores a registration for all valid coin data sets so that the user can check the validity of the coin data sets with the aid of the coin register. Since the coin register only comprises registration data sets, it does not have access to the coin data sets themselves.

WO 2020/212331 A1 uses and expands this third approach by which the coin data sets can be exchanged directly between the users. In WO 2020/212331 A1, a directly exchanged coin data set can also be passed on to a further recipient without a connection to the coin register being necessary. The recipient or the further recipient can later generate a new coin data set in the same amount and transmit a request to the coin register that the registration of the old coin data set in the coin register be replaced by a registration of the new coin data set in the same amount. It is further described that a local coin managing unit of the user can transfer coin data sets into a user's vault module depending on a requirement, in the form of a threshold value for a total amount in the coin managing unit.

### SUMMARY

It is the object of the present invention to create a method, a coin managing unit, and a system in which a payment transaction is designed to be secure but nevertheless simple.

This object is achieved with a coin managing unit, with a method for creating a coin managing unit and with a method in a coin managing unit.

A coin managing unit comprises a secure execution unit for managing digital coin data sets and at least one digital coin data set. The secure execution unit is adapted to exchange digital coin data sets with other coin managing units in transactions and to transmit registration requests to a coin register. The secure execution unit is further adapted to check a first requirement and/or a second requirement for a transaction.

The first requirement and the second requirement are stored in the coin managing unit as requirement data elements. The first requirement and the second requirement relate to the same check criterion, wherein the second requirement is an increase of the first requirement and/or the second requirement is to be checked for a different exchange direction than the first requirement.

The coin managing unit can thus execute transactions securely and under compliance with the requirements. The requirements are not defined by the secure execution unit, but are contained separately in a data element, so that increased flexibility is achieved.

The second requirement can be selectable by a user as an increase of the first requirement. Preferably, the first requirement is defined in advance by an issuer of the coin managing unit. The user cannot change the first requirement. The second requirement can be selected depending on the first requirement only in such a way that an increase of the first requirement results overall. For the same check criterion, there can therefore be an issuer requirement, which is defined for the user of the coin managing unit, and a user requirement, which the user can select. However, the user requirement is an increase of the issuer requirement or is narrower than the issuer requirement. Of course, requirements that are valid system-wide are (permanently programmed in the secure execution unit and) no longer definable by the issuer or selectable by the user. The issuer can accordingly also define its requirements only narrower than the system requirements or as an increase of the system requirements. The secure execution unit thus complies with system requirements and also checks the (functional and other) requirements of the coin managing unit. A requested transaction is only executed (or stored in the event of a conditional transaction) when both requirements (first and second requirements) are met.

The first requirement can (alternatively or additionally) be a receipt requirement and the second requirement can be a transmission requirement. The two requirements pertain to the same check criterion, but must be checked for a different exchange direction, transmitting or receiving, of digital coin data sets. When coin data sets are received in the transaction, the receipt requirement must be checked. When coin data sets are transmitted in the transaction, the transmission requirement must be checked. The transaction is only executed (or stored in the event of a conditional transaction) when the transmission and/or receipt requirement(s) are met.

The secure execution unit will preferably check several, in particular, a plurality of first and/or second requirements for the transaction. The requirements described here are in each case stored in the coin managing unit as requirement data elements. A plurality of pairs of transmission and receipt requirements and/or of user and issuer requirements can be present.

In particular, for the check criterion, there can be one (or more) requirement quadruples, which (in each case) comprise a first receipt requirement and a second increased receipt requirement and a first transmission requirement and an increased second transmission requirement. Preferably, a receipt and a transmission requirement of the issuer and a receipt and a transmission requirement of the user are present.

In particular insofar as it does not pertain to the other exchange direction, the second requirement is an increase of the first requirement. An increase of the first requirement exists in particular if the second requirement makes it more difficult to satisfy the requirement or, as a result of the second requirement, fewer conceivable transactions satisfy the requirement.

The second, increased requirement comprises, for example, an increased numerical value (e.g.: threshold for maximum value: second requirement value lower than the first requirement value; threshold for minimum value: second requirement value greater than the first requirement value). The check criterion can be a comparison of the requirement value as a threshold (> or >= or < or <=) with a numerical value of the transaction (such as transaction amount, number of coin data sets, time requirement . . . ) or of the coin managing unit (such as number of coin data sets, amount sum of the coin data sets, number of transactions in time period or transaction sum in time period). The transaction is executed (or stored as a conditional transaction) when the corresponding numerical value of the transaction or of the coin managing unit complies with the threshold contained in the requirement (threshold criterion).

However, the second, increased requirement can also comprise, for example, at least one (or more)—in comparison with the first requirement—additional non-permissible comparison value(s). The check criterion can be a negative criterion. The requirement contains non-permissible comparison values, which the transaction must not contain (as a transaction data element or transaction property). The transaction is only executed (or stored as a conditional transaction) when the comparison value is not a transaction data element (such as sender, recipient, transaction type, . . . ) or property of the transaction.

The second, increased requirement can preferably be a selection or restriction of the permissible comparison values (of the first requirement). The check criterion is preferably a positive criterion. The requirement contains permissible comparison values, which the transaction may contain (as a transaction data element or transaction property). The transaction is only executed (or stored as a conditional transaction) when the comparison value is contained in the transaction.

The secure execution unit can check the first and the second, increased requirements one after the other or only check the second requirement, which comprises the first requirement. If the requirements are checked one after the other, increased security is achieved. The second requirement can optionally comprise the first requirement (i.e., a selection or restriction of the permissible comparison values of the first requirement or the non-permissible comparison values of the first requirement and at least one additional non-permissible comparison value). In this case, it is sufficient to check only the second requirement. The secure execution unit will only store a (user) requirement selected (by the user) as a second requirement when it is an increase of the first requirement and/or will store it in such a way that it is an increase of the first requirement. If, for example, only the second requirement is checked, it will form the logical sum of the two requirements and only store this when an increase of the first requirement results.

The previously mentioned and further mentioned requirements will generally differ in the coin managing unit. The requirement can represent a full restriction (such as “no transmitting”), a partial restriction (e.g., indication of permissible recipient) or a lack of restriction (such as “all recipients”). For example, the transmission requirement and the receipt requirement for the check criterion are different. The direction requirements are therefore preferably designed asymmetrically for a coin managing unit. The transmission requirement can completely restrict or partially restrict the transmission of coin data sets to precisely one recipient, precisely one recipient group or to a plurality of recipients and/or recipient groups. The recipient(s) and/or recipient group(s) are contained in the requirement, in particular by indication of a recipient ID, a recipient group ID or a portion of a recipient ID, or a certificate group. A certificate can have a coin managing unit as a member of a group, for example, as a group certificate, such as “ID/key belonging to group XY,” or as an attribute certificate, such as “attribute YZ met.” In the requirement, a recipient group can also be indicated, for example, by the group and/or a certificate type, such as “certificate for group XY” or “certificate for attribute YZ.” For example, the requirement can request a certificate for the attribute “bookstore” from the publisher group “SchöneBücher.” Similarly, the receipt requirement can completely restrict or partially restrict the receipt of coin data sets to precisely one sender, precisely one sender group or multiple senders and/or sender groups. The sender and/or sender group(s) are contained in the requirement, in particular by indication of a sender ID, a sender group ID or a portion of a sender ID, or a certificate group. In the requirement, however, a sender group can also be indicated by a group and/or a certificate type, for example, such as “certificate for group XY” or “certificate for attribute YZ”. The check criterion can be the transaction partner of the transaction, in particular in its role as sender or recipient of coin data sets.

Senders and/or recipients can be indicated by their coin managing unit identifier, for short: sender ID or recipient ID. Sender and/or recipient groups can be indicated, for example, by a portion of a coin managing unit identifier. In particular, each recipient or sender belongs to the group if its coin managing unit identifier comprises the portion, i.e., begins, for example, with this portion or differs only by an individual portion of the identifier.

The first and the second requirements can be requirements for conditional transactions. Requirements for conditional transactions preferably contain a type of condition, such as time-related, event-related or security-value-related, and/or a type of conditional transaction (for example, a simple transaction or a complex transaction, such as, for example, with counter-performance or with a plurality of recipients or with recipient and sender), in particular the permissible types which are permissible for the coin managing unit. There can be various types of conditional transactions, which differ in terms of their complexity and/or their coding (conditional transaction encoded according to standard A or type B or proprietary C . . . ). The various types of conditional transactions are supported by the secure execution unit, but in the present case are still permitted only selectively or in a restricted manner for the coin managing unit.

The secure execution unit will in particular temporarily store a conditional transaction (only) when the requirements for conditional transactions are met. The secure execution unit will only execute a conditional, in particular temporarily stored, transaction when a condition is met. The conditional transaction can in particular comprise a temporal condition, an external triggering event as a condition and/or a security value as a condition. The temporal condition preferably indicates a point in time after which the conditional transaction is to be executed. The secure execution unit recognizes that the temporal condition has been met, i.e., in particular the point in time has been reached, and executes the transaction. The temporal condition can indicate, alternatively or as an additional point in time after which the conditional transaction is no longer to be executed (executable “until” or “from until”). Such a temporal condition is generally linked to an additional condition. A conditional transaction can comprise an external condition (triggering event) and/or a security value. The temporarily stored conditional transaction is only executed when the security value has been received and/or a confirmation for the presence of the external condition/for the external event has been received. For example, a random value or a cryptographic security value (hash of data/signature of data) can serve as a security value. In particular, the recipient of the transaction or a third party can trigger the transaction if he knows the security value and transmits it as a trigger (possibly together with the ID of the coin managing unit and/or a transaction number).

Conditional transactions are preferably executed exactly once. However, it is possible to provide conditional transactions which are executed several times, in particular even with or without a restriction on the number of executions (e.g., every 2 weeks or event-related exactly four times). The requirement for conditional transaction can restrict the number of executions that may be contained in the conditional transaction.

Likewise, the first and the second requirements or an additional requirement can be an amount requirement. The user, issuer, transmission or receipt requirements can be amount requirements. The amount requirement can be a maximum value of the amount of the coin data sets to be transmitted and/or the amount of the coin data sets to be received. Likewise, the amount requirement can be a maximum value (or a minimum value) of a total amount of the coin data sets stored in the coin managing unit or of a transaction sum of the transactions executed by the coin managing unit in a time period (such as 1 hour, 1 day, 1 week, . . . ).

(Amount-independent) requirements for existing functions, such as temporary storage of conditional transactions, transmitting or receiving coin data sets . . . , of the secure execution unit can be referred to as functional requirements. Preferably, one of the existing functions of the secure execution unit is restricted, in particular restricted independently of the amount, by the functional requirement. The functional requirements preferably pertain to one (of a plurality of) function(s) executable by the secure execution unit. The executable function is completely or partially restricted by the functional requirement. Amount requirements are not functional requirements in the present sense.

A complete restriction, such as, for example, “no transmitting” or “no receiving” in a direction requirement, can be stored differently in a requirement. The complete restriction is preferably stored as content of the requirement (such as “not permissible” or “no”). Alternatively, storing an empty content (“or”) or an invalid content (such as “−” as a number, ID, or . . . ) could indicate the complete restriction. It can be provided to store one (or more) non-restricting requirement(s). An example would be a coin deposit that may transmit to any recipients but may only receive from certain senders. In preferred embodiments, the non-restricting requirement is indicated by the absence of this requirement, in the example: for the coin deposit there is a sender requirement but no recipient requirement. Alternatively, however, the content of the functional requirement can indicate that the functional requirement does not contain any restriction, in example: recipient requirement with content “any”, “all”, “*” or the like.

One or more of the following data elements are preferably also stored in the coin managing unit:
a unique coin managing unit identifier, and/or
a public coin managing unit key of an asymmetric key pair; optionally a secret coin managing unit key of the asymmetric key pair; and/or
a coin managing unit certificate, which in particular comprises the coin deposit identifier and/or the public coin deposit key as certified content.

One of the following is preferably used as the coin managing unit identifier:
a Uniform Resource Identifier (URI), in particular according to RFC 3986,
a Uniform Resource Name (URN), in particular according to RFC 8141, and/or
a Universally Unique Identifier (UUID), in particular according to RFC 4122. The URI can contain a UUID and/or a URN.

The URI comprises as portions, for example, a scheme, such as a URN or UUID, a provider, such as an operator name or domain name of the operator, and the unique portion, such as a UUID or serial number. In one example:

urn:uuid:965ecc78-3182-4d5b-8f6a-le325b336031.

The URN comprises as portions, for example, a resource type (example: coin managing unit), an operator name, usually the domain name of the operator (example: myBank.com), and a unique portion (examples: serial number or UUID), which is unique at least for the operator, but preferably system-wide. A sender and a recipient of a transaction could then be indicated, for example, as follows: sender ID: coinmanagingunit:my-bank.com:dlafujr3jbd″ or recipient ID: coinmanagingunit: your-bank.com: 3hbbda903988r″.

In a UUID “xxxxxxxx-xxxx-Mxxx-Nxxx-SVxxxxxxxxxx” according to RFC 4122, the version is encoded in the half-byte M and the variant of the UUID is encoded in the half-byte N. A functional requirement can now be indicated in at least one additional portion of the UUID, such as the half-bytes S and/or V (in version 4, variant 1). For example, it can thus be encoded in the half-byte S that the coin deposit is present in a coin deposit managing unit. At least short functional requirements can be encoded in a portion of the UUID such as this or an additional half-byte. For example, “no direction restriction”, “no transmitting” or “no receiving” could be encoded in 3 bits. Likewise, a requirement for conditional transactions could be encoded in the 3 bits or additional 3 bits, for example, the permissibility of three types of conditions or of three types of conditional transactions could be encoded.

The coin managing unit identifier can comprise at least one (short) functional requirement or a portion of the functional requirements. A certificate can contain more data than an identifier. Accordingly, the coin managing unit certificate can contain one or more functional requirements.

The first and/or the second coin deposit can comprise a partially freely readable requirement, in particular also the first or second functional requirements. In particular, a readable portion and a non-readable portion of the at least partially freely readable requirement can be present. The two portions are preferably stored in different data elements, in particular a freely readable data element, such as the coin managing unit certificate or identifier or a non-confidential requirement data element, and in a non-freely readable data element of the coin deposit, such as a dedicated confidential requirement data element. Alternatively, the two portions are stored in a common data element in a not freely readable manner, and the readable portion is additionally stored in a separate readable data element, such as the coin managing unit certificate or identifier or a non-confidential requirement data element.

The first and/or the second requirement can be a counter-performance requirement. Preferably, the counter-performance is provided in response to at least one received coin data set as performance, in particular in the response data to the sender of the received coin data set.

The secure execution unit can transmit transaction register data to a transaction register for managing the coin data sets. The transaction register data comprise in particular a unique transaction identifier, a transaction amount, a coin managing unit identifier of the sender, a coin managing unit identifier of the recipient, and the (at least one) register reference of the coin data set in the coin register.

Alternatively or additionally, the secure execution unit can transmit registration requests to the coin register for managing the coin data sets, which in particular comprises at least one register reference of a coin data set previously registered in the coin register and a register reference of a coin data set to be registered in the coin register.

Alternatively or additionally, the secure execution unit can receive a transaction request for managing the coin data sets (from a user or another coin managing unit) and/or transmit a coin data set (execute transactions with other coin managing units). The transaction request comprises in particular a transaction amount, a coin managing unit identifier of the sender, and a coin managing unit identifier of the recipient. Only optionally, it also comprises a unique transaction identifier and/or a transaction reference text. Executing a transaction with another coin managing unit comprises the transfer of at least one coin data set from the coin deposit to the other coin managing unit (recipient).

The coin managing unit can be a local coin managing unit (of the user). Alternatively, the coin managing unit is a server-based coin managing unit, which either comprises a separate secure execution unit for the user of the coin managing unit or comprises a common secure execution unit for a plurality of users, in a coin deposit managing unit with coin deposits of the users. Each coin deposit of a user in the coin deposit managing unit forms, together with the common secure execution unit, a coin managing unit, which can be designed in the present sense.

In order to manage the coin data sets in a transaction with an additional coin managing unit, the secure execution unit can evaluate a received data element of the additional coin managing unit. The additional data element can completely or partially comprise a requirement of the additional coin managing unit, and the secure execution unit can check the requirement of the additional coin managing unit for the transaction.

In preferred embodiments, the coin deposit managing unit provides an interface for the retrieval of requirements (and/or conditions) of the coin deposits for other coin managing units. The other coin managing unit transmits the ID of a coin deposit of the coin deposit managing unit to the interface. In response to a retrieval for a coin managing unit ID, the associated, readable requirements and/or conditions of the coin deposit are transmitted, in particular separately from a certificate (for the public key) of the coin deposit or in addition to a certificate (for the public key) of the coin deposit.

Each coin deposit in the coin deposit managing unit forms a coin managing unit together with the secure execution unit. The coin deposit managing unit thus comprises coin managing units of different users. In contrast, coin managing units of a user with his own execution unit manage only coin data sets in one (or more) coin deposit(s) of the user.

A first and a second coin deposit can be assigned to a first (the same) user. The first user has two coin deposits in the coin deposit managing unit, which comprise different requirements. The user can one or more coin deposits in the coin deposit managing unit and one (or more) local coin managing unit(s). The local coin managing unit of the user can be present, for example, in the form of a security module, such as a chip card, SIM card, RFID token, NFC module, built-in security module or integrated security module. The coin deposit managing unit is provided by an operator, which can be, for example, a financial service provider, such as a business bank, a credit card provider or a payment service provider (PayPal, etc.).

The coin deposit managing unit stores the coin deposits preferably in encrypted form. The coin deposit data set (of the coin deposit) is only decrypted in order for the coin deposit data to be read. Particularly preferably, the coin data sets are individually encrypted, further preferably encrypted with individual keys. The coin deposit managing unit can advantageously comprise a high-security module, which stores at least one key. The high-security module provides the (or the individual, optionally individually derived) decryption keys. The high-security module can also store additional keys, such as the at least one secret key of the (or each) coin deposit, which can serve, for example, for signature generation, authentication, or decryption. The secure execution unit then requires, for example, a signature, an authentication value or a decryption from the high-security module so that the secret keys are only used in the high-security module. As an alternative to the use of a high-security module, the management of the keys can also be divided among a plurality of computers in the coin deposit managing unit; only the plurality of computers together can calculate and/or use the key required in each case.

A method for outputting a new coin managing unit, comprising a secure execution unit for managing digital coin data sets, for a user includes the following steps.
Receiving a request to create the new coin managing unit;
providing the new coin managing unit with stored data elements, wherein a secure execution unit is configured to check first and/or second requirements for a transaction. In the present case, the request comprises at least the first requirement, and the data elements stored in the provision step comprise the first requirement as a requirement data element. The first requirement is an issuer requirement defined for the user, and a second requirement that can be stored as a data element is provided for the same check criterion. The second requirement is either to be checked for a different exchange direction than the first requirement or, after the provision step, can be selected by the user as an increase of the first requirement.

The coin managing unit for outputting the new coin managing unit can also execute one or more of the following steps:
Checking an authentication contained in the request;
generating a coin managing unit identifier, which in particular comprises a portion of a requirement, preferably of the first requirement;
generating a coin managing unit key;
providing a coin managing unit certificate, which in particular comprises a portion of a requirement or an additional portion of the requirement, preferably of the first requirement. The certificate preferably comprises the ID and/or a public key of the coin managing unit. The provision may comprise creating the certificate in the coin managing unit. Alternatively, the certificate is created externally and received by the coin managing unit.

An authentication for the request is preferably checked by checking an authentication that is contained in the request. Alternatively, the authentication of the requester can also be checked already before or after receipt of the request. The requester is the issuer of the coin managing unit. In the case of a coin deposit managing unit, this is the issuer of the coin managing unit for which a new coin deposit is created. The issuer is therefore neither the user of the coin deposit nor the operator of the coin deposit managing unit.

The steps of generating the identifier, key, and/or certificate preferably take place before the data elements of the new coin managing unit (or the coin deposit data) are stored, so that the stored data elements comprise at least the identifier and optionally also the key and further optionally the certificate. Alternatively, in particular in a coin deposit managing unit, one or more of the generating steps can also take place after the step of storing the data elements of the new coin managing unit (or of the coin deposit data). The new coin deposit is preferably stored without the certificate of the coin managing unit, further preferably also without the key of the coin managing unit and alternatively or even more preferably without the identifier.

The request can comprise a user(name) for which the new coin managing unit is created. The user(name) is not usually stored in the data elements of the coin managing unit. An assignment of ‘coin managing unit to user’ is preferably stored in a separate storage unit by the issuer or the operator of the coin deposit managing unit. In particular if the user is already known, the identifier, key, and certificate of the coin managing unit will have already been generated during the creation of the coin managing unit and stored in the coin deposit, i.e., not generated and stored afterwards.

The new coin managing unit can also be created without a user assignment. An assignment of the created new coin managing unit to a user then takes place in response to an assignment request. The assignment request requests the assignment of a coin managing unit to the user, which in turn is preferably stored in the separate memory unit of the issuer of the coin managing unit or the operator of the coin deposit managing unit. The assignment request can be received by the issuer, the user, or a third party. The assignment request of the user or third party may comprise an authorization code that the user has received from the issuer.

The stored data elements of the coin managing unit preferably comprise at least one coin data set. Preferably, in order to manage digital coin data sets the secure execution unit will
receive a coin data set for the new coin managing unit, and/or
transmit a registration request to a coin register which, in particular as a replacement for a received coin data set previously registered in the coin register, requests the registration of a coin data set to be stored in the new coin managing unit. In the coin register, the new coin data set is then registered (stored as valid) and the previously registered coin data set is no longer registered (deleted or stored as invalid).

As already indicated, the coin managing unit can be a server-based coin managing unit, which either comprises a separate secure execution unit for the user of the coin managing unit or comprises a common secure execution unit for a plurality of users, in a coin deposit managing unit with coin deposits of the users. Creating a new coin deposit in the coin deposit managing unit corresponds to outputting a new coin managing unit.

A method for managing coin data sets in a coin managing unit comprising a secure execution unit and at least one coin data set contains the following steps:
Receiving a transaction request;
reading data elements stored in the coin managing unit;
checking a first requirement and/or a second requirement;
executing a transaction or storing a conditional transaction corresponding to the transaction request.

In the present case, the first requirement and the second requirement are stored in the coin managing unit as requirement data elements. Accordingly, the first requirement and/or the second requirement are read in the reading step. The first requirement and the second requirement pertain to the same check criterion, wherein the first requirement is an issuer requirement and the second requirement is a user requirement and/or the first requirement is a receipt requirement and the second requirement is a transmission requirement.

The issuer requirement and the user requirement can be direction requirements. Alternatively or additionally, the first and second requirements are requirements for conditional transactions and/or counter-performance requirements and/or amount requirements. The executed transaction can be a simple transaction (transmission or reception of coin data set), with or without provision of a counter-performance, or a previously stored transaction, with or without provision of a counter-performance. Likewise, the stored conditional transaction can be a transaction with or without provision of a counter-performance.

In the checking step, a data element of the transaction request, in particular a transaction amount or a transaction partner, and/or a data element of the coin managing unit, which is changed by the execution of the transaction, is checked for the transaction, in particular compared with the requirement. For a data element of the coin managing unit, a resulting state of the data element is preferably compared with the requirement after the requested transaction has been executed. It is thus checked in particular whether the threshold value of the requirement would be exceeded by the transaction. Furthermore, in the checking step, the transmission requirement and/or the receipt requirement can be checked, depending on the exchange direction of the transaction. In addition, either only the user requirement, which is narrower than the issuer requirement, can be checked, or both the user requirement and the issuer requirement can be checked. Furthermore, in the checking step, different requirements, in particular a plurality of requirements for different data elements of the transaction or of the coin managing unit, can be checked, depending on the requested transaction.

The user of the coin deposit generally transmits a transaction request. In embodiments, the transaction request can also be transmitted from another coin managing unit or a transaction partner (sender or recipient of coin data sets) to the coin deposit managing unit. When the transaction request is received by the user, the conditional transaction can be stored as a conditional transaction released by the user.

Alternatively or additionally, the conditional transaction can only be temporarily stored and later executed when a triggering condition is met, or when stored as a release frame of the user for later transaction requests of a third party that is mentioned in particular as a recipient in the conditional transaction. The transaction request or an additional transaction request from a third party, in particular the recipient of the transaction, can be a triggering condition for a stored conditional transaction. In this case, either the temporarily stored conditional transaction is executed or a transaction requested by the third party is executed that falls under the stored conditional transaction released by the user (requested transaction amount smaller than and/or equal to the stored amount and requested recipient corresponds to the stored recipient or stored recipient group).

The execution of the transaction, in particular of the requested or the conditional transaction, can comprise:

transmitting or receiving a coin data set of the central bank, and/or
transmitting a registration request to a coin register of the central bank,
which requests the registration of a coin data set to be stored in the new coin managing unit, in particular for a received previously registered coin data set, and/or
transmitting transaction register data to a transaction register, and/or
providing a counter-performance, wherein in particular the transaction request comprises a coin data set.

As already stated, the step of executing the transaction comprises transmitting at least one coin data set from the coin managing unit to a recipient (or receiving at least one coin data set which is contained in particular in the transaction request). In the step of executing the transaction, a coin data set to be transferred can be generated and registered in the coin register, in particular if the amount of the coin data set to be transferred should correspond to a transaction amount. At least one coin data set, i.e., optionally two or more coin data sets, of the coin managing unit are transferred in the step of executing the transaction. Coin data sets can be transferred separately or in transaction messages, for example, together with a transaction ID, in particular if an encrypted connection is already established between the sender and the recipient. Alternatively, however, a complete transaction message can also be transferred (directly between coin deposit managing units). A complete transaction message contains in particular the data elements contained in the transaction request and the at least one coin data set.

Transaction requests, coin data sets, and/or complete transaction messages can preferably be contained in an HTTP message. Transaction requests, coin data sets, and/or complete transaction messages can alternatively or additionally be transferred in a JSON format. The JavaScript Object Notation (JSON) format preferably corresponds to RFC 8259 (and/or ECMA 404 or ISO/IEC 21778). A transaction ID can be formatted as a UUID. A transaction request could then, for example, be formatted as follows:

{
″Sender″: ″urn:coinmanagingunit:my-bank.com:dlafujr3jbd″,
″Recipient″: ″urn:coinmanagingunit: your-bank.com:3hbbda903988r″, “Amount″: “1.60 eCBDC″
“Transaction reference text”: “Event number 1234898942”
}
An associated transaction message, here with 2 coin data sets, could then be formatted,
for example, as follows:
{
″TransactionID″: ″lcl02b5f-5496-459d-8a67-3bflc348bll3″,
″Sender″: ″urn:coinmanagingunit: my-bank.com:dlaidjr3jbd”, “recipient”:
“urn:coinmanagingunit:your-bank.com:3hbbda903988r”, “coin data sets”: [
{
″Amount″: 1000, ″... Number”:“116e782982383e9d0ea2c728f2a5f80d8a6121″
},
{
″Amount″: 60, ″... Number″: “Iaaa77777777777733333c9123812123712814″
}
],
“Transaction reference text”: “Invoice 1234898942”
}

The coin managing unit can be designed as described above. The methods described can be executed one after the other for a coin managing unit.

A digital currency system comprises a plurality of the coin managing units described, the coin register, and optionally a plurality of coin deposit managing units and/or a transaction register.

The present solution is particularly advantageous since the high flexibility in the coin managing unit can be offered independently of the coin register and/or the transaction register. In particular, the coin register, which is already subject to particularly high requirements in a digital currency system, is not slowed down.

### BRIEF DESCRIPTION OF THE DRAWINGS

The invention and further embodiments and advantages of the invention will be explained in more detail below with reference to figures, wherein the figures merely describe exemplary embodiments of the invention. Identical components in the figures are provided with the same reference numbers. The figures are not to be considered true to scale; individual elements of the figures may be illustrated excessively large or excessively simplified.

### IN THE FIGURES

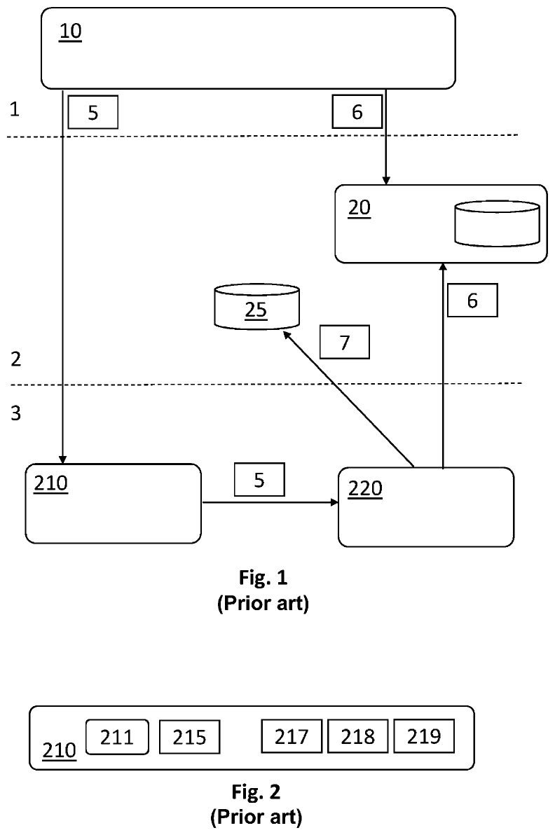

FIG. 1 shows a digital central bank currency system with coin managing units and a coin register of the central bank;

FIG. 2 shows a coin managing unit with an execution unit and a coin data set;

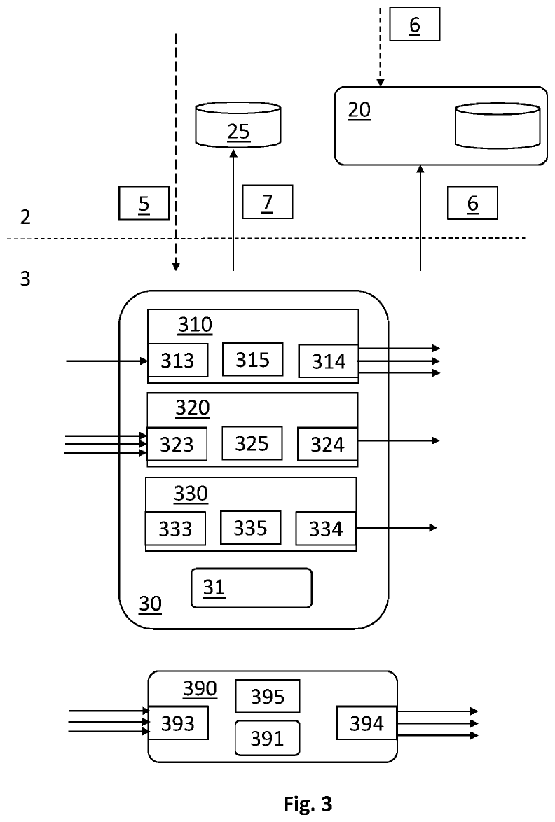

FIG. 3 shows a digital central bank currency system with a coin deposit managing unit;

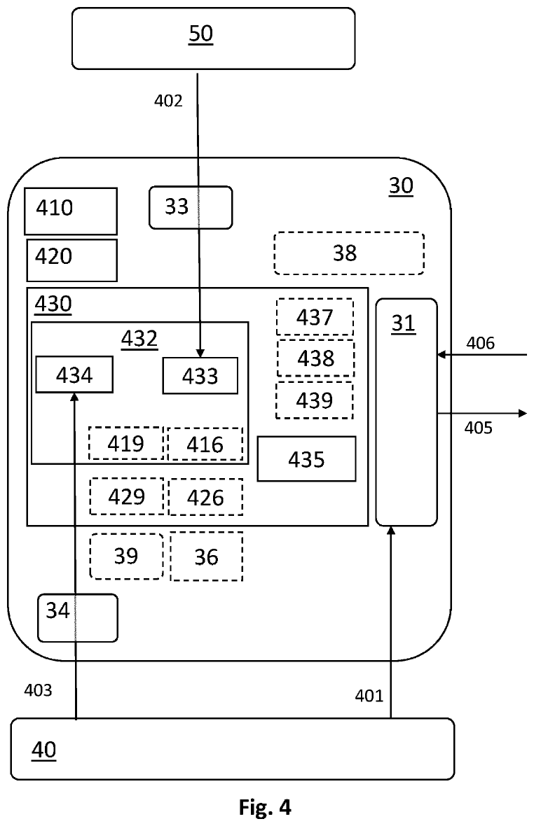

FIG. 4 shows a coin deposit managing unit;

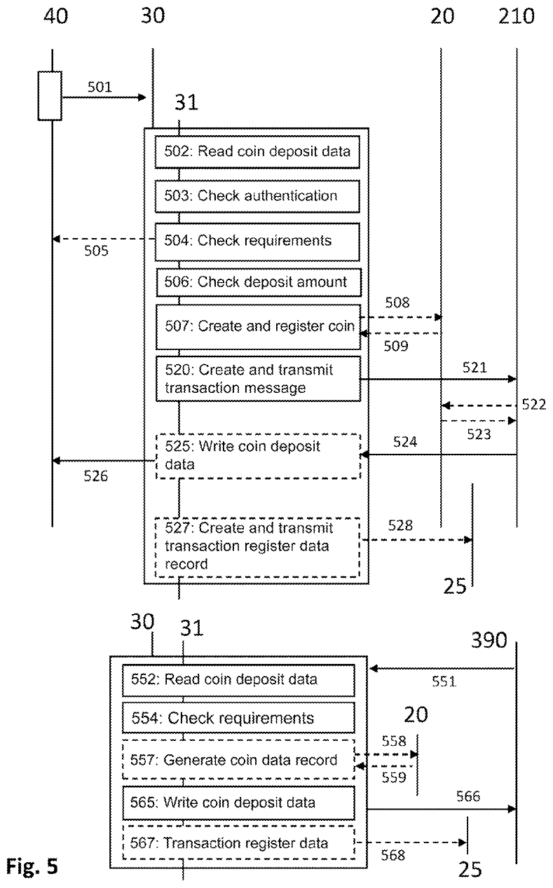

FIG. 5 shows a flowchart for a method with a transaction request;

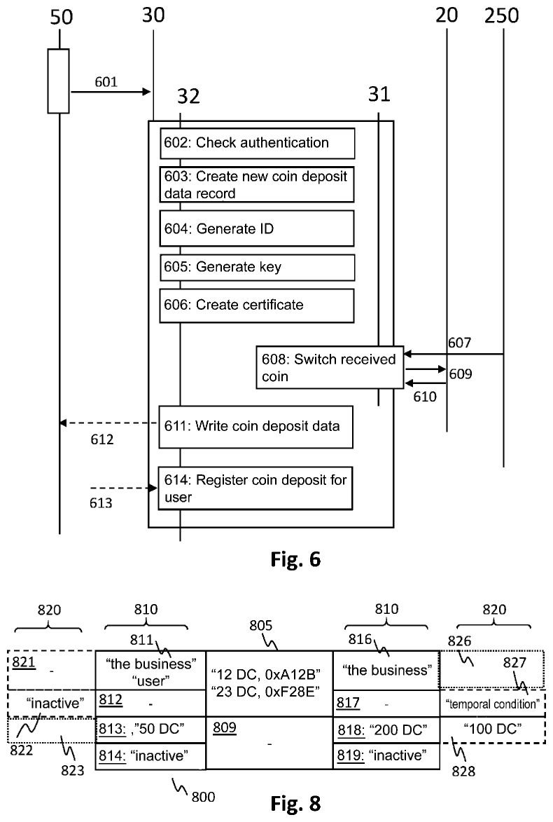

FIG. 6 shows a flowchart for a method with a coin deposit request;

FIG. 7 shows a flowchart for a method with a request for a conditional transaction;

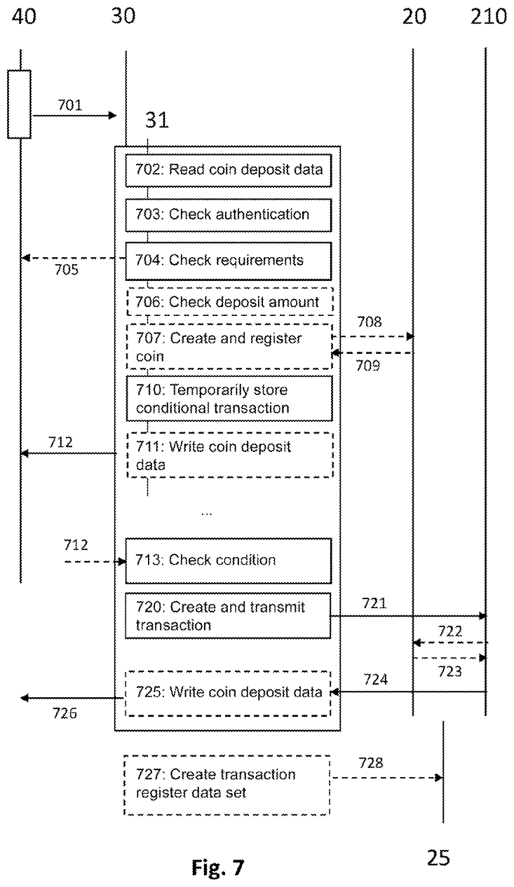

FIG. 8 shows an exemplary embodiment for requirements of a coin deposit.

### DETAILED DESCRIPTION OF VARIOUS EMBODIMENTS

FIG. 1 shows a digital central bank currency system, as is already known per se. The division of the system into an output layer 1, a system management layer 2 and a transaction layer 3 is shown by dashed lines.

A central bank entity 10 issues digital coin data sets 5. The central bank entity 10 also requests an initial registration of the digital coin data set 5 in a coin register 20 of the central bank. Coin managing units 210, 220 can exchange digital coin data sets and transmit registration requests to the coin register 20.

Transaction data sets 7 are stored in an optional transaction register 25. A transaction data set 7 is, for example, the transaction amount, a transaction ID, identifiers for sender and recipient, here the coin managing unit 210 as the sender and the coin managing unit 220 as the recipient, and at least the register reference of the transferred coin data set 5.

The coin register 20 stores a register data set 6 at least for each valid digital coin data set 5. The register data set 6 contains, for example, the amount of the coin data set and a register reference. The register reference can be derived from the coin data set 5, but does not allow the determination of the coin data set 5. In FIG. 1, the initial registration request transmitted by the central bank entity 10 contains the register data set 6. In the figure, it is shown that the first coin managing unit 210 receives the digital coin data set 5 from the central bank entity 10. However, the digital coin data set 5 can also be issued indirectly by the central bank to a coin managing unit of a user (e.g., via a commercial bank) or have been received from another coin managing unit.

The digital coin data set 5 can be transferred from the first coin managing unit 210 directly to the second coin managing unit 220. The second coin managing unit can check the validity of the coin data set 5 with the aid of the coin register. It can transmit a validity request, which contains the register reference that can be derived from the coin data set 5 and optionally the amount, to the coin register 20. The coin register 20 checks whether the register reference is present and, if applicable, confirms that the coin data set 5 is valid. Alternatively, the coin managing unit 220 generates a new coin data set and transmits a registration request, which comprises at least the register reference of the previously valid coin data set 5 and a register reference of the new coin data set, to the coin register 20. The registration request is checked in the coin register 20. In the simplest case, the register reference of the new coin data set is registered and the previously valid register reference is deleted (or marked as invalid).

If a coin managing unit 210, 220 generates a new coin data set in the same amount and registers the new coin data set instead of the previous coin data set, this is also referred to as a switchover. However, coin managing units 210, 220 can also divide or connect coin data sets, i.e., generate a new coin data set to be registered from a plurality of previously valid coin data sets or generate a plurality of coin data sets to be registered from one previous coin data set. The coin register 20 then checks in particular whether the registration request (with the associated plurality of previous or new register references) is neutral in terms of the amount. WO 2020/212331 A1 describes corresponding examples. However, the present solution is not bound to the masking of the amount of the coin data sets described there or to the specific protocols in WO 2020/212331 A1.

The approach shown in FIG. 1 is particularly advantageous, since neither the coin register 20 nor the transaction register 25 have to comprise coin data sets 5. FIG. 2 shows a coin managing unit 210 with its typical components. The coin managing unit 210 comprises an execution unit 211 and at least one coin data set 215. The execution unit 211 is generally designed as software and is configured to manage the coin data sets of the coin deposit (transmit/receive coin data sets, transmit registration requests).

Furthermore, the coin managing unit 210 comprises an identifier of the coin managing unit 217 as a data element. In the following, identifiers are also sometimes referred to as IDs for short, for example, as a sender ID or recipient ID. A cryptographic key 218, optionally an asymmetrical key pair, and a certificate of the coin managing unit 219 are additional data elements of the coin managing unit 210. The cryptographic key preferably serves to authenticate the coin managing unit and/or to sign data, in particular in the context of a transaction. The certificate can pertain to the identifier and/or the key, generally the public key of a key pair 218, of the coin managing unit.

In FIGS. 1 to 4, data elements, such as the coin data sets 215, are shown with rectangular boxes, and functional units, such as the execution unit 211, are shown with rounded corners. The contents described in relation to FIGS. 1 and 2 are known per se, but are also used below.

FIG. 3 shows a coin deposit managing unit 30 with a plurality of coin deposits 310, 320 and 330 of different users and an execution unit 31 for managing coin data sets. The coin deposits 310, 320, 350 comprise at least one coin data set 315, 325, 335. The coin deposits 310, 320, 330 are coin deposit data sets, i.e., consist of data elements, such as the at least one coin data set in each case and additional data elements. A coin managing unit 390, which comprises an execution unit 391 and coin data sets 395, is also shown. The coin deposits 310, 320, 330 each form independent coin managing units 310.31; 320.31; 330.31 together with the common execution unit 31. Each of the coin managing units 310.31; 320.31; 330.31; 390 will comprise its own IDs, keys, and/or certificates.

Both the coin deposit managing unit 30 and the coin managing unit 390 are arranged in the transaction layer 3. For the sake of completeness, the coin register 20 of the central bank with register data sets 6 and the optional transaction register 25 with a transaction data set 7 are also shown in the system management layer 2 in addition to a coin data set 5.

The coin managing units 390; 310.31; 320.31; 330.31 or the coin deposits 310, 320, 330 each comprise two direction requirements for different exchange directions. The first requirement is a receipt requirement 393; 313; 323; 333 and the second requirement is a transmission requirement 394; 314; 324; 334. In the figure, the direction requirements are symbolized by means of the arrows shown. The arrow direction shows the exchange direction (transmission or reception of coin data sets). The different number of arrows already indicates that the requirements can be different. The requirements stored as data elements, such as the direction requirements, are checked by the execution unit 31, 391 before a transaction is executed.

An example will now be described in which the direction requirements contain permissible recipients or senders. Receipt requirements can comprise permissible (or impermissible) senders (sender requirement). Transmission requirements can correspondingly comprise permissible recipients (recipient requirement). However, direction requirements can also comprise amount requirements as an alternative or in addition to sender requirements or recipient requirements.

The receipt requirement 313 of the first coin deposit 310 contains only one sender ID of a coin managing unit and thus restricts the receipt for the first coin deposit 310 to this sender of coin data sets. The sender ID could, for example, belong to a coin managing unit of the user or an issuer of the first coin deposit 310. The coin deposit 310 can then receive coin data sets only from the user or from its issuer. By contrast, the transmission requirement 314 of the coin deposit 310 does not contain any restriction. The coin deposit 310 could thus transmit coin data sets to any other coin managing unit. The first coin deposit 310 is thus unrestricted with regard to the recipient and partially restricted with regard to senders.

The receipt requirement 323 of the second coin deposit 320 contains a plurality of permissible sender IDs and/or one or more permissible sender groups. The second coin deposit 320 can thus receive coin data sets of different coin managing units. However, these have to have an ID which is contained in the receipt requirement 323, or belong to the sender group, which can also be recognized from the ID. The second coin deposit 320 is more restricted in the transmission direction than in the receipt direction. The transmission requirement 324 comprises, for example, only one or two permissible recipients or only one permissible recipient group. The second coin deposit 320 is thus partially restricted with regard to the recipients and less restricted with regard to senders.

The third coin deposit 330 again comprises other direction requirements. There are no permissible senders according to receipt requirement 333. The execution unit 31 will thus not perform any receipt transactions for the coin deposit 330. The transmission requirement 334 contains a recipient ID (or a recipient group). The third coin deposit 330 can transmit its coin data sets only to this/these recipient(s). The third coin deposit 330 is thus partially restricted with regard to the recipients and completely restricted with regard to senders.

The coin managing unit 390 could initially serve as a counterexample if it were unrestricted in both directions, i.e., can transmit to any IDs or can receive from any IDs. In the present case, however, the coin managing unit 390 also comprises a plurality of recipient IDs (and/or recipient groups) in its receipt requirements 393 and a plurality of sender IDs (and/or sender groups) in the transmission requirements 394. The coin managing unit 390 can thus be restricted symmetrically or asymmetrically by the requirements.

Each of the coin deposits 310, 320 and 330 is assigned to a user. However, the assignment of the coin managing unit ID to the user is preferably not stored in the coin deposit and further preferably not in the coin deposit managing unit 30, but rather in an external (not shown) data structure (which contains the ID together with the complete name of the user). The coin deposit managing unit 30 comprises coin deposits of different users; the coin deposits shown can be assigned to different users or at least some of them to a single user.

In embodiments, the coin managing unit does not contain a direction requirement for a non-existent restriction. However, the direction requirement preferably contains the non-restriction. For example, it is encoded by “*” or “all” for any IDs.

It should be noted that a direction requirement can comprise not only exactly one ID, or a plurality of IDs, but can also comprise groups of IDs or mixtures of groups and individual IDs. A group of IDs can be indicated, for example, by an ID mask. The ID mask provides only portions of an ID which must correspond, such as “ABC??1311560*”. For example, all IDs that have a particular initial portion and/or middle portion (in the example, beginning “ABC” and middle “1311560”) can be permissible independently of the specific values in additional portions (in the example, the two characters?? or a serial number following in the final portion).

An additional possible embodiment will now be described with reference to FIG. 3 on the basis of another interpretation of the meaning of the arrows by the coin deposits 310, 320, 330 and 390. The number of arrows indicates the maximum level of the permitted transaction amount (of one transaction). In FIG. 3, a low maximum amount, such as 10 DC or 20 DC (DC=digital currency units), could be indicated by one arrow, and a high maximum amount, such as 1000 or 2000 DC, could be indicated by three arrows. No arrow means that the maximum amount is equal to zero. A system limit valid in the digital currency system, of for example 5000 DC, is always taken into account (checked) by the execution units. In contrast, the amount requirements contained in the data elements of the coin managing units are specific to the coin managing units.

In a transmission transaction, the first coin deposit 310 could at most receive the small first maximum amount, but transmit at most the higher second maximum amount. In a transmission transaction, the second coin deposit 320 could at most receive the higher second maximum amount and transmit at most the smaller first maximum amount. The third coin deposit 330 is severely restricted in terms of amount when transmitting and may (in turn) accept no receipt transactions. The coin managing unit 390 would be equally restricted for the transaction amount of a transmission requirement or of a receipt transaction.

As already indicated, each of the direction requirements can also comprise an amount requirement in addition to a sender or recipient requirement.

An issuer of a coin deposit could, in one example, provide a coin deposit 330 with coin data sets 335 for a user and define the only permissible recipient or a single permissible recipient group in advance.

An issuer of coin deposits could, in another example, create the second coin deposit 320 without a receipt restriction and the first coin deposit 310 without a transmission requirement restriction for a user. The second coin deposit 320 is thereby restricted to transmitting to the first coin deposit 310. The first coin deposit 310 can be unrestricted or differently restricted in the receipt direction.

FIG. 4 shows a coin deposit managing unit 30, a user unit 40, and an issuer entity 50.

The coin deposit managing unit 30 in turn comprises coin deposits 410, 420, 430 and the execution unit 31. The coin deposit data set of the coin deposit 430 is shown in more detail; it contains requirements 432 and exactly one coin data set or a plurality of coin data sets 435.

Data elements or units that may be optional are shown here and in the additional figures with dashed lines. For example, an identifier 437, at least one key 438 and a certificate 439 (in each case of the coin managing unit, formed by the coin deposit 430 and the execution unit 31 of the coin deposit managing unit 30) are contained in the coin deposit 430 as optional, but generally present, data elements.

The requirements 432 comprise issuer requirements 434 and user requirements 433. The issuer requirements 434 are permanently predefined by the issuer of the coin deposit. They can already be contained in a coin deposit request 402. In contrast, the user requirements 433 can be freely selected by the user, at least if they are narrower than a (possibly existing, similar) issuer requirement 433. The user requirements 434 are an increase of the issuer requirements 433. The issuer requirements 433 remain valid in this respect. They are checked in addition to the user requirements 434 or are incorporated (directly or indirectly) into the user requirements. Proceeding from a fully restricting issuer requirement, such as “no transmitting” or “no receiving”, the user no longer has any freedom of choice. Starting from an unrestricted (possibly non-existent) requirement of the issuer, such as “transmit to all” and/or “receive from all” and/or “no amount restriction”, the user can select a user requirement completely freely. Starting from a partially restricting requirement of the issuer, such as “transmitting only to ID group 1 or to ID group 2”, the user (optionally for himself) can select a narrower user requirement, such as “transmitting only to ID 1 from ID group 1 or to ID 2 from ID group 1”. Starting from an existing amount threshold of the issuer, such as “at most 500 DC”, he can select (optionally for himself) a check-based increased amount threshold, as “a maximum of 400 DC”.

The coin deposit managing unit 30 comprises a coin deposit creation unit 33, which can process a coin deposit request 402 of the issuer and a user requirement unit 34, which can process a configuration request 403 of the user. A user can transmit the configuration request 403 to the coin deposit managing unit 30 from his user unit 40, such as mobile data device, PC, or terminal.

The user requirement unit 34 checks in particular whether the requirements for his coin deposit 330 contained in the configuration request 403 and selected by the user are an increase of the existing issuer requirements 433 of the coin deposit 330. In this case, the requirements in the configuration request 403 are stored in the coin deposit 330 as user requirements 434. In the coin deposit managing unit 30, the user requirement 434 can always be narrower than the issuer requirement 433 and the restrictions of the issuer requirement 433. It is then sufficient that the secure execution unit 31 checks the user requirement 434. When indicating the permissible recipients and/or senders in the requirement, this variant is preferred. On the other hand, the secure execution unit, preferably for other requirements or encodings, can also be configured to always check both requirements 433, 434. The user requirement 434 then does not have to comprise the possibly existing restrictions of the issuer requirement 433. The management of the user requirement(s) 434 can thus be simplified.

The coin deposit 330 can be or have been created as a new coin deposit at the request 402 of the issuer entity 50. The coin deposit request 402 contains, as a data element, at least one, generally a plurality of issuer requirements 433 for the new coin deposit 330. A corresponding method is described in more detail below with reference to FIG. 6.

The execution unit 31 is configured to exchange the coin data sets of the coin deposits in transactions 405, 406 with other coin managing units and to transmit registration requests to the coin register.

A key management module 38 of the coin deposit managing unit 30 is preferably a high-security module for cryptographic keys. The key management module 38 can store secret keys of the coin deposits 310, 320, 330. The key 338 of the coin managing unit 330, 31 stored in the coin deposit 330 is, for example, a public key of an asymmetrical key pair. The associated secret key is stored in the key management module 38 (and only used in this module). The key management module 38 encrypts, authenticates or signs, for example, data for the secure execution unit 31 with the secret key or other keys of the coin deposit. Individual key pairs can be provided for the different purposes. The key management module 38 may additionally create and use derived keys, such as session keys (or provide them to the execution unit).

In addition to managing the transaction keys (keys required for the transactions), the key management module 38 can also be used for the encrypted storage of the coin data sets.

The data sets of the coin deposits 310, 320, 330 are preferably stored in encrypted form in the coin deposit managing unit 30. If required, i.e., for example in a transaction request or configuration request for the coin deposit 330, the coin deposit is decrypted. Only the coin deposit 330 is decrypted, wherein in particular a key that is individual for the coin deposit can be used. The key management module 38 can, for example, execute the decryption (and a later re-encryption). If the key management module 38 contains a derivation key (optionally jointly for a plurality of coin deposits), it can alternatively provide the derived key for the decryption/encryption of the coin deposit of the secure execution unit 31.

The user can transmit a transaction request 401 from his user unit 40 to the coin deposit managing unit 30. A corresponding method for processing the transaction request 401 is described for the case of transmitting a coin data set, transmission transaction 405, with reference to FIG. 5. The execution unit 31 checks the requirements 432 before the transmission transaction is executed (or not) depending on the check result. The check of the requirement 432 is also described with reference to FIG. 5 for the case of receiving coin data sets (receipt transaction 406).

The requirements 332 can be not only direction requirements, but also, for example, requirements for conditional transactions 416 or requirements for transactions with counter-performance 419. In FIG. 3, it is already indicated that these requirements 416, 419 can also additionally exist.

A storage region 426, 36 for the (temporary) storage of conditional transactions can be provided in the coin deposit 330 or across coin deposits. Conditional transactions are first stored and later executed after the condition has been met. A corresponding method is described in more detail with reference to FIG. 7.

In order to be able to execute a transaction with counter-performance, the coin deposit managing unit 30 comprises a counter-performance unit 39. The counter-performance unit generates, for example, response data, which are to be transmitted in a response as a counter-performance for one (or more) coin data sets received in a receipt transaction 406. The counter-performance unit provides a counter-performance that can be set in counter-performance data 429 of the coin deposit 330. The counter-performance requirements 419 restrict the counter-performance functions permissible for the coin deposit 330. Starting from the counter-performance functions available in the counter-performance unit 39, specific counter-performance functions, encodings or subtypes are thus selectively excluded for the coin deposit.

The concept of issuer and user requirements that build on each other was described with reference to FIG. 4 for coin managing units of a coin deposit managing unit, but is analogously applicable to coin managing units with their own secure execution unit. As an alternative to the direction requirements 393, 394 (or additionally in the direction requirements 393, 394), the coin managing unit 390 from FIG. 3 can thus comprise issuer and user requirements. The user can, for example, select, for a defined issuer requirement in the reception direction and/or in the transmission direction (transmitting example: “sender group and maximum amount=200 DC”), a user requirement increased in comparison (in the transmitting example: “2 sender IDs from sender group and maximum amount=150 DC”).

FIG. 5 shows a method sequence 501 to 528 in the coin deposit managing unit 30, which begins with the receipt of a transaction request 501 from a user 40 (or the user's user unit), as well as the method sequence 551 to 568 when receiving coin data sets from a coin managing unit 390.

The transaction request 501 comprises an ID of a coin managing unit (or of the coin deposit) in the coin deposit managing unit 30 and requests the transmission of an amount from this sender ID to a recipient ID. The secure execution unit 31 of the coin deposit managing unit 30 reads the coin deposit data of the coin deposit. Preferably, the key management module 38 of the secure execution unit 31 either provided the decryption key, which is selected individually for the coin deposit, or provided the already decrypted coin deposit data. In steps 503, 504, 506, the secure execution unit 31 executes a plurality of checks before it executes the requested transaction in steps 507 to 526. FIG. 5 shows the preferred sequence of the checking steps. First, an authentication is checked 503, generally the authentication of the user. A corresponding authentication value can be contained in the transaction request 501 or can be requested and received separately in step 503.

At least one (of the) requirement(s) of the coin deposit is checked in step 504. In the present example of a simple transmission transaction, it is checked whether the recipient ID is an ID according to the functional requirement. If the coin deposit according to the issuer requirement is unrestricted in the receipt direction or the issuer requirement is met in the receipt direction, the user requirement, which comprises an ID group and two IDs of recipients, will be checked. If the recipient ID of the transaction request does not correspond to the requirement, the transaction request 501 will be rejected; the user 40 receiving a rejection message 505. If, in contrast, the recipient ID is permissible because it is an ID from the ID group or corresponds to one of the two IDs of recipients in the user requirement, the method will be continued (and the transaction executed). In step 506, it is checked whether the deposit amount, i.e., the amount of the coin data set in the coin deposit or the sum of the amounts of the coin data sets in the coin deposit, is greater than the requested amount.

The coin deposit managing unit 30 preferably transmits precisely one coin data set in transactions, the amount of which corresponds to the transaction amount, instead of transmitting the transaction amount as the sum of amounts of several coin data sets. If the requested amount corresponds to the amount of an existing coin data set in the coin deposit, the next steps 507 to 509 will be omitted. In step 507, a new coin data set is created, the amount of which corresponds to the requested amount. Preferably, an existing coin data set is divided into the new coin data set and an additional coin data set (amount=difference between the amount of the existing coin data set and the transaction amount). Alternatively, two or more existing coin data sets could be connected to the new coin data set (and optionally one or more additional coin data sets). A registration request 508 is transmitted to the coin register 20 for the new coin data set (or its register reference). The coin register 20 confirms 509 the registration.

In step 520, the secure execution unit 31 now creates a transaction message 521, which is transmitted to the coin managing unit 210 with the recipient ID. The transaction message 521 comprises a transaction ID, the ID of the coin deposit, the recipient ID, and the new coin data set. Optionally, the transaction message 521 contains a transaction reference text, which generally originates from the transaction request, and/or an authentication value, which is generated for the transaction with the aid of the secret key of the coin deposit. Preferably, a mutual authentication of the two coin managing units (310, 31 and 210) involved is carried out for the transaction, in particular in step 521. The step 520 of creating and transmitting the transaction message 521 can run in a plurality of sub-steps with a plurality of exchanged sub-messages (only, for example, for the authentication).

The coin managing unit 210 optionally generates its own coin data set, which in particular is equal to the amount of new coin data set received, transmits a registration request 522 for its own coin data set to the coin register 20 and then receives a registration confirmation 523 from the coin register 20. The coin managing unit 210 transmits a transaction confirmation 524 to the coin deposit managing unit 30.

In step 525, i.e., preferably only after receipt of the transaction confirmation 524, the secure execution unit 31 stores the changed coin deposit data of the coin deposit. As described above, a coin deposit-specific encryption of the coin deposit data can take place, in turn optionally with the aid of the key management module 38.

A transaction confirmation 526 can be transmitted to the user 40. In preferred variants, a transaction register data set 528 is created in step 527 and transmitted to the transaction register 25.

A JSON format is preferably used for the transaction request 501 and/or the transaction message 521. A first, uniform format, in particular the JSON format, is preferably used for messages within the transaction layer 3. However, it should be noted that the contents of the transaction request 501 and/or the transaction message 521 can also be transferred separately from one another. For example, an authentication value can first be transmitted in step 503 or a recipient ID can first be transferred in step 504 and/or an authentication of the coin managing unit 210 (or a mutual authentication) can initially be executed before a coin data set is exchanged.

The second sequence shown in FIG. 5 is triggered by reception of a transaction message 551 or by a receipt transaction from a coin managing unit 390. The transaction message 551 contains at least one ID of a coin deposit in the coin deposit managing unit 30. The coin managing unit 390 thus wants to transmit a coin data set to the coin deposit. However, the secure execution unit in turn checks whether the transaction corresponds to the requirements of the coin deposit.

First, the coin deposit data of the coin deposit with the indicated ID are read 552. The reading 552 of the coin deposit data will comprise, as before, a decryption. Optionally, an authentication of the coin managing unit 390 is checked or a mutual authentication is executed. Now the secure execution unit 31 checks 554 the requirements of the coin deposit. If receiving is completely restricted for the coin deposit, for example, the transaction message 551 will be rejected. In the example, however, receiving is partially restricted for the coin deposit by a sender requirement of the issuer. The secure execution unit 31 thus checks whether the ID of the coin managing unit 390 meets the sender requirement of the issuer for the coin deposit. In the negative case, the transaction is rejected; in the positive case the transaction is executed. The secure execution unit preferably generates its own coin data set using the received coin data set. It can generate its coin data set 557 in the same amount and register it with the coin register by registration request 558 and registration confirmation 559. The coin deposit data of the coin deposit are stored 565 (encrypted) and a transaction confirmation 566 is transmitted to the coin managing unit 390. Optionally, a recipient of coin data sets may also be obligated in the digital central bank currency system to generate 567 a transaction register data set 568 and to transmit 568 it to the transaction register 25.

The sequences described in FIGS. 5 to 7, in each case for a coin deposit with a common execution unit, can run analogously in a coin managing unit with its own execution unit. The method is at best slightly easier, since the identification of the coin deposit and the decryption can initially be omitted.

In FIG. 5, the transmission transaction was requested by the user, but it is conceivable that the transaction request is received by the other coin managing unit 210, 390. However, such a transmission transaction request of a third party, in particular of the recipient, should then comprise an authentication value of the user or would need to be separately released by the user (in step 503). It would theoretically even be conceivable to define a release request criterion for third-party transaction requests. If the criterion is met, a release will be requested for the transaction requested by the third party. The joint effect of criteria and requirements is no longer sufficiently reliably transparent for some users. As will be described with respect to FIG. 7, there is a better way to enable third-party transmission transaction requests.

FIG. 6 shows the sequence of a method for outputting a new coin managing unit, here by creating a new coin deposit. An issuer 50 of the new coin deposit transmits a coin deposit request 601 to the coin deposit managing unit 30. The coin deposit creation unit 32 of the coin deposit managing unit 30 processes the coin deposit request 601 and creates the new coin deposit. First, the authentication of the issuer is checked 602. If the check of the authentication fails, for example, because the requester is not an issuer but a user, the request will be rejected (or no new coin deposit created). The coin deposit managing unit 30 comprises a plurality of coin deposits assigned to different users. The coin deposits comprise different requirements, in particular different issuer and user requirements, which can contain transmission and/or receipt requirements. The plurality of coin deposits has been created by a plurality of issuers. The plurality M of the coin deposits is in the order of magnitude of a plurality B of the users (M=a*B, for example where 1<a<9 for 1 to 9 coin deposits per user). The plurality of coin deposits M is orders of magnitude greater than the plurality H of the issuers: M>>H (for example: M=b*H where b>50, preferably>100).

In step 603, a coin deposit data set for the new coin deposit is created. The data elements of the generated coin deposit data set are initially empty and/or occupied by a default value. In the step of creating 603 the coin deposit data set, the individual encryption key can be provided for the coin deposit, in particular by the key management module 38. The data elements, such as requirements and coin data sets, or in particular also identifier, key and/or certificate, are now provided in additional steps 604-608 or incorporated from the coin deposit request 601.

First, an identifier for the new coin deposit is generated 604 in the coin deposit managing unit 30. The new coin deposit forms a new coin managing unit together with the secure execution unit 31. Identifiers are assigned in the system to coin managing units. The identifier is designed, in particular, as a URI, Unified Resource Identifier, or URN, Unified Resource Name, and contains a universally unique ID (UUID). An identifier as a URN has, for example, the following format: “coinmanagingunit:my-coin-deposit-bank.com:UUID”. A UUID can be used as an identifier or as a part of a URN. The UUID is encoded according to RFC 4122. It accordingly comprises a half-byte M, which indicates a version of the UUID, and a half-byte N, which indicates a variant of the UUID. Additional bits of the UUID are now used to at least partially encode a functional requirement. For example, bits of the half-bytes S and/or V can be used here: “xxxxxxxx-xxxx-Mxxx-Nxxx-SVxxxxxxxxxx”, which would otherwise be occupied by random numbers. In a first bit of the UUID, it is encoded that the coin deposit is present in a coin deposit managing unit. In a second bit of the UUID, it is encoded whether a direction-related functional requirement is present (“0”: no direction requirement, “1”: “direction requirement”). In a third bit of the UUID, it is encoded whether conditional transactions are permissible (“0”: “no conditional transactions” or “1: conditional transactions permissible”). In a fourth bit of the UUID, it could optionally be encoded whether a counter-performance is permissible (“0”: no counter-performance permissible, “1” counter-performance permissible). For conventional coin managing units, the 3 bits of the UUID could thus be set to “000”.

For the new coin deposit, according to coin deposit request 601, transmission should be restricted to two different recipient groups, and a named variant of conditional transactions should be permissible which can comprise a counter-performance. The three bits of the UUID are therefore set to “111” for the new coin deposit.

As expected, only one (or more) direction requirement exists for the plurality of coin deposits in the coin deposit managing unit 30, but conditional transactions or counter-performances are not permitted. For most coin deposits, the three bits would thus be encoded with “100” in their URN or UUID.

In an additional step, at least one key for the coin deposit is provided or generated. A key pair comprising a public key and a secret key is generated, preferably by the key management module. The secret key can optionally remain in the key management module. Alternatively, it is stored in encrypted form in the (optionally additionally encrypted) coin deposit. The public key is stored in the coin deposit. The key or the key pair preferably serves to authenticate the new coin managing unit.

In an additional step 606, a certificate is created for the coin deposit. The certificate comprises at least the ID and/or the public key of the coin deposit. Certificates confirm the authenticity of the contained data elements for third parties. The certificate, like the ID or the public key, is a (public) data element of the coin deposit data set provided for forwarding to third parties, such as other coin managing units. The requirements for counter-performance are therefore not contained in the certificate. The exact restriction in the transmission and receipt directions, i.e., here the two permissible recipient groups, are also treated as internal information. However, an (additional) part of the requirements is contained in the certificate. The certificate contains, for example, the indication that the coin deposit is unrestricted in the receipt direction (“no sender requirement”) and is partially restricted in the transmission direction.

Optionally, the secure execution unit 31 receives 607 one or more coin data sets for the new coin deposit. As already described above, the secure execution unit will generate its own (or a plurality of its own) coin data set(s) for the received coin data set(s). It transmits a registration request to the coin register 609 and receives a confirmation 610 for the registration of its own coin data set(s) in the coin register 20. Generally, own coin data sets in the same amount are generated and registered (switching). It is not shown in the figures that, in turn, a transaction register data set is preferably transferred to the transaction register 25.

In step 611, the coin deposit data set, in particular including the mentioned data elements, of the externally provided data elements, and optionally at least one coin data set, is stored. It is preferably stored in individually encrypted form. The encryption can pertain to the entire coin deposit data set or to individual data elements (D1, D2, D3) (e.g.: “encrypt(D1, D2, D3 . . . )” or “encrypt(D1), encrypt(D2), encrypt(D3) . . . ”.

After the new coin deposit has been created, the coin deposit creation unit 32 can transmit a coin deposit confirmation 612 to the issuer 50.

A step 614 of registering the new coin deposit for a user can take place at different times. The assignment between a unique user name, optionally including “first name, last name, date of birth, and/or address” or “tax number with or without, first name, last name” of the user and the coin deposit, i.e., the ID of the coin deposit, is generally stored in an external data structure. If the user is already named in the coin deposit request 601, the assignment or the registration 614 can take place as soon as the ID of the coin deposit is fixed (in the example: from step 604).

The registration 614 in FIG. 6 is triggered with a separate assignment request 613, which pertains to at least one coin deposit already created but not yet associated with a user. The issuer 50 could thus have had a plurality of new coin deposits created (steps 601 to 612). The coin deposits (which are not yet usable) are assigned to a user (steps 613, 614) only as necessary (at a later point in time and optionally individually). It is conceivable for a plurality of coin deposits to simultaneously request the assignment. The issuer can transmit the assignment request 613. Generally, the user is then informed that a new coin deposit has been created for him (for example, including indication of the ID or access data). Alternatively, the user or a third party can transmit the assignment request 613. The issuer shares an authorization code with the user (e.g., in an email and/or as a barcode). The user or a third party who first verifies the identity of the user (e.g., by means of postal identification or video identification methods) then transmits the authorization code with or in the assignment request 613.

The coin deposit preferably does not yet comprise any coin data sets at the time of registration 614. Thus, for example starting from the transaction register 25, all transactions can be assigned to users in the system.

It can now be seen that the aspects or features described for individual figures can also be used individually or together in other figures. The new coin deposit according to FIG. 6 can be, for example, a coin managing unit according to any one of FIGS. 2 to 8. In order to avoid repetitions, not all details relating to each figure are repeated again or not all the alternatives are mentioned for each of the details. The key management, communication with the coin register and the transaction register, and in particular the differently combinable requirements are only a few corresponding examples.

FIG. 7 shows the sequence of a method when a conditional transaction is requested. The request for a conditional transaction 701 from the user 40 first triggers almost the same steps 702, 703, 706, 707, 708 as a normal transaction to be executed immediately with steps 502, 503, 506, 507, 508 in FIG. 5. Since, as in FIG. 5, a transmission transaction is also considered as a conditional transaction in FIG. 7, the later steps 720 to 728 correspond respectively to the known steps 520 to 528. Such steps, which have already been described, will be discussed only briefly.

The coin deposit data 702 of the coin deposit indicated with its ID in the transaction request 701 is read and the user authentication 703 of the user 40 is checked, for example, as described in FIG. 5.

Analogously, the request 701 will also be rejected 705 if it is determined when checking 704 the requirement(s) of the coin deposit that the transaction is not permissible for the coin deposit.

In the checking step 704, (at least also) a requirement for conditional transactions is checked as a functional requirement, only, for example, whether the type of condition is permissible. In addition to the requirement for conditional transactions, a direction requirement and/or an amount requirement, for example, can optionally be checked, in the present example of a transmission transaction, the requirement for the transmission direction and a possibly existing amount limit for the transmission. One or more requirements for conditional transactions can thus be checked in addition to the general requirements (for simple transactions). However, the requirements for conditional transactions can also comprise direction requirements for conditional transactions and/or amount requirements for conditional transactions.

The additional steps of checking the deposit amount 706 and of creating 707 and registering a coin data set 708, 709 for the transaction could in turn take place analogously to FIG. 5.

A conditional transaction is first (temporarily) stored 710. It has therefore not yet been executed, but rather is executed only later when the condition contained in the transaction is met. As is shown in FIG. 4, the temporary storage can be into a buffer store for conditional transactions 426 of the coin deposit 330 or in an overarching coin deposit buffer store 36 for conditional transactions. It should be noted that the sequence shown, first checking 703 to 705 then temporarily storing 710, ensures that the conditional transaction can actually be executed as soon as the condition is met.

In an optional step 711, the secure execution unit 31 stores the coin deposit data set, in particular if the coin deposit data have changed. Storing 711 or temporarily storing 710 may in turn comprise encrypting the coin deposit data, as previously described. The coin deposit data will have changed, for example, if the buffer store 426 of the coin deposit is used. Likewise, with the optional steps 707 to 709, a coin data set can already have been generated for the conditional transaction. The coin data set for the conditional transaction can be stored in the coin data sets of the coin deposit. It is preferably marked there as a coin data set reserved or blocked for the conditional transaction. In an alternative, the coin data set for the conditional transaction could be temporarily stored in the conditional transaction itself, in particular when the buffer store 426 of the coin deposit is used. In an additional alternative, the coin data set for the conditional transaction is created only after temporary storage 710. There are various possibilities for ensuring that the temporarily stored transaction can be executed. The transaction amount can be subtracted from the available deposit amount (for steps of checking the deposit amount such as steps 706 or 506). If the available deposit amount is provided as a separate data element of the coin deposit, it will be reduced. An amount reserved for conditional transactions could also be provided as a data element of the coin deposit data set. An additional possibility for saving storage space would be to take into account not only the available coin data sets in steps of checking 506, 706 the deposit amount, but also to read the temporarily stored conditional transactions of the coin deposit.

The three dots after step 711 in FIG. 7 indicate that the additional steps 712 to 728 follow only at a later point in time. The processing of the transaction request 701 for a conditional transaction is concluded.

The conditional transaction is executed only if and/or only when the condition has been met. FIG. 7 shows a step of checking the condition 713, which is executed, for example, at regular time intervals or is executed in response to the reception of a check trigger 712.

The conditional transaction can, for example, comprise a temporal condition. The transmission transaction is not executed until a specific date or until a certain point in time (for example, after 36 hours or after 11:00 pm or on a specific day of the week).

The conditional transaction can comprise a security value. The transaction is not executed until or is only executed when the security value of the secure execution unit has been provided. The security value can be a random number or a cryptographic security value which is derived in particular from the data of the conditional transaction (such as a hash value or a signature, about a portion of the conditional transaction or the conditional transaction respectively). The security value can in particular be received as the or in the check trigger 712.

The conditional transaction can comprise an external triggering event. The occurrence of the external triggering event is preferably received in or with the check trigger 712 (from a third party or the transaction partner). The content of the data received with the check trigger 712 is then checked. Alternatively, the secure execution unit can check, for example, by requesting from an external server or an external data structure (such as blockchain or database) whether the triggering event has occurred.

The conditional transaction can furthermore comprise a temporal limit (execution before a point in time or date). The condition, such as the security value or the external event, must thus be met before the temporal limit is reached. Once the temporal limit is reached, the conditional transaction will no longer be executed. A temporarily stored conditional transaction is deleted after its temporal limit has passed.

A conditional transaction is optionally executed exactly once or several times. The number of executions of the conditional transaction can be indicated in the conditional transaction.

A requirement for conditional transactions can indicate, for example, a permissible type or the permissible types of condition, such as temporal condition, security value, and/or external event. Alternatively or additionally, a requirement for conditional transactions can contain a type of the conditional transaction which is permissible for the coin deposit. For example, the requirement can indicate whether a conditional transmission transaction is permissible, possibly unrestricted or partially restricted in accordance with a general transmission requirement or in accordance with a separate transmission requirement for conditional transactions. Analogously, the requirement can indicate whether a conditional receipt transaction, a conditional transaction with counter-performance, or a conditional transaction according to a specific scheme (default 1 or proprietary 2) is permissible. Such requirements for conditional transactions can in particular be defined by the issuer in advance for the coin deposit and/or selected by the user. As already stated, they functionally restrict the coin deposit to certain functions from the available functions that the secure execution unit provides.

The additional steps of creating 720 the transaction (message), exchanging at least one coin data set 721 to 724, writing 725 the coin deposit data, confirming the transaction 726, and registering the transaction in the transaction register 727, 728 have already been described in relation to FIG. 5.

Just as a coin deposit can comprise a plurality of direction requirements and amount requirements, the coin deposit can also comprise, alternatively or additionally, a plurality of requirements for conditional transactions (such as requirements from issuer and/or user for the different types and/or directions).

Up to now, it has been described and considered in relation to FIG. 7 that the conditional transaction is temporarily stored and then executed as temporarily stored. A modified use of a conditional transaction is conceivable in which the conditional transaction is stored which corresponds to the transaction request of the user. A transaction requested by a third party (or its coin managing unit) will be executed when it meets the stored conditional transaction. The stored conditional transaction is a release frame of the user for transactions of the third party that is preferably named as the recipient in the conditional transaction. However, the coin managing unit of the third party can now request not only exactly the stored conditional transaction (as a trigger), but also, for example, a transaction with a lower transmission transaction amount than in the stored transaction value threshold. The transmission transaction request of a third party can thus also be executed if a suitable conditional transaction has been previously stored by the user.

In the example of FIG. 8, different requirements in a coin managing unit are described, again only using the example of a coin deposit data set instead of the example of the corresponding data elements of the coin managing unit. This can in principle and with different content be present in each of the discussed coin managing units (possibly with coin deposit).

A plurality of requirements 811-828 are shown as data elements of a coin deposit data set 800 and two coin data sets are shown in the coin data sets 805 in a symbolically simplified manner (amount 13 or 23 with “DC” as digital currency units of the central bank currency).

The coin deposit comprises, on the one hand, issuer requirements 810 and user requirements 820. On the other hand, it comprises both receipt requirements 811-814; 821-823 and transmission requirements 816-819; 826-828. Based on the representation in FIG. 3, the receipt requirements are arranged on the left of the coin data sets 805 and the transmission requirements are arranged on the right thereof in FIG. 8.

Finally, for functional requirements, a distinction is made between direction requirements 821, 811, 816, 826, requirements for conditional transactions 822, 812, 817, 827 and requirements for transactions with counter-performance 814, 819. The coin deposit also comprises amount requirements 813, 838, 828. However, amount and direction requirements can in each case also be part of the requirements for conditional transactions or counter-performance requirements, as partially described above.

The issuer defined the issuer requirements 810 at the point in time of the creation of the coin deposit. The user requirements 820 are selected by the user, but selected narrower than the similar issuer requirements 810 or more precisely as an increase of the issuer requirements 810.

In the example, the issuer is the owner of a business. He restricts the coin deposit created by him for the user, therefore in the transmission requirement 816 to his business “the business”. In practice, the transmission requirement 816 therefore contains the ID(s) of the coin management unit(s) of the business and not a plain text name, as shown in the figure. The user can thus transmit coin data sets of the coin deposit created by the issuer only to the permanently indicated business. The user is not allowed to additionally restrict this requirement in the example; for this reason he is not prompted to select a transmission requirement of the user 826. This is indicated in the figure by a box with a dotted-line border. In the receipt direction, the issuer has provided in its receipt requirement 811 that coin data sets may be received from the business or from the user. The user can select an increased user receipt requirement 821 (optionally and therefore shown by dashed lines). In the example, the user has not selected a receipt requirement, but could have selected, for example, a restriction to “the business” or to “none.”

As can be seen in the issuer requirements for conditional transactions 812, 817, the issuer has not restricted the coin deposit of the user separately with regard to conditional transactions. However, its transmission and receipt requirements 811, 816 are also valid for conditional transactions. The user has decided to not allow conditional receipt transactions, as can be seen in the user requirement 822 for the receipt direction of conditional transactions (“inactive”). Furthermore, the user does not want to allow just any conditional transmission transactions, but only to allow the type of condition useful for him, the temporal condition that he wants to use for the business. He has selected “temporal condition” in his user requirement 827.

For the coin deposit, the issuer has also permanently specified amount requirements 813, 818. According to the issuer requirement 813, the coin deposit may receive a maximum of 50 digital currency units in a transaction and, according to the issuer requirement 818, transmit a maximum of 200 digital currency units in a transaction.

An additional restriction of the amount is not offered to the user in the receipt direction (dotted box) for user requirement 823. In the transmission direction, the user has selected 50 digital currency units as the maximum transmission amount for his coin deposit in the requirement 828.

Finally, the issuer has excluded the existing option of executing transactions with counter-performance with the coin deposit. The issuer requirements for transactions with counter-performance 814, 819 are a complete restriction (“inactive”).

The user can now, for example, first transmit 50 DC from another coin managing unit to the coin deposit. A deposit amount of 85 DC is then present in total in the coin deposit. He could now transmit the entire deposit amount in a single transaction to the indicated business (in a new coin data set with 85 DC or with the three existing coin data sets). However, he can also create a conditional transmission transaction that uses a temporal condition, provided that the recipient is the business. The user could, for example, request a conditional transmission transaction which transmits 20 DC to the coin managing unit of the business every two weeks. As described with respect to FIG. 7, the requested transaction is checked, stored temporarily and then executed every two weeks. The business then provides the user with a counter-performance, indicated in advance or in a transaction reference text, every two weeks (depending on the business:

a vegetable box, fresh coffee or lawn-mowing). However, the counter-performance can also be transmitted in digital form, in particular in an email, SMS, or a response to the transaction message (in example: access code to fitness studio valid for 2 weeks).

The encoding of the requirements 811-828 is shown as text for better readability in the figure, but can be encoded in any length and encoding (one or more bits, one or more bytes, byte sequences . . . or with numerical, hexadecimal, binary, string . . . encoding). An encoding of the data elements of the coin managing unit or coin deposits as TLV structure (tag, length, value) is also conceivable as an encoding of the coin deposit in a JSON format. The issuer data 809 can contain, for example, an expiry time for the coin deposit (validity limit). More of the already mentioned data elements of a coin deposit, such as, only by way of example, the additional data elements 437-439 or 429, 426 from FIG. 3, are not shown but can of course exist.

Within the scope of the invention, all of the elements described and/or shown and/or claimed can be combined with one another as desired.

1-27. (canceled).

28. A coin managing unit, comprising:
a secure execution unit for managing digital coin data sets, wherein the secure execution unit is adapted to exchange digital coin data sets with other coin managing units in transactions and to transmit registration requests to a coin register; and
at least one digital coin data set;
wherein the secure execution unit is additionally adapted to check a first requirement and/or a second requirement;
wherein the first requirement and the second requirement are stored in the coin managing unit as requirement data elements; and
the first requirement and the second requirement pertain to the same check criterion,
wherein the second requirement is an increase of the first requirement and/or the second requirement is to be checked for a different exchange direction than the first requirement.

29. The coin managing unit according to claim 28, wherein the second requirement can be selected by a user as an increase of the first requirement;
wherein the first requirement is defined in advance by an issuer of the coin managing unit.

30. The coin managing unit according to claim 28, wherein the first requirement is a receipt requirement and the second requirement is a transmission requirement.

31. The coin managing unit according to claim 28, wherein
the secure execution unit checks a plurality of, first and/or second, requirements for the transaction, and/or
the secure execution unit checks the first and the second requirement one after the other or only checks the second requirement, which comprises the first requirement; and/or
at least one reference quadruple pertains to the check criterion, comprising a first receipt requirement and a second increased receipt requirement and a first transmission requirement and an increased second transmission requirement.

32. The coin managing unit according to claim 28, wherein the second increased requirement comprises:
a numerical value that is increased with regard to the check compared to the first requirement,
at least one additional non-permissible comparison value, or
a selection or restriction of the permissible comparison values.

33. The coin managing unit according to claim 30, wherein
the transmission requirement differs from the receipt requirement; and/or
the transmission requirement completely restricts or partially restricts the transmission of coin data sets to exactly one recipient, exactly one recipient group or to a plurality of recipients and/or recipient groups; and/or
the receipt requirement completely restricts or partially restricts the receipt of coin data sets to exactly one sender, exactly one sender group or a plurality of senders and/or sender groups; and/or
the check criterion is the transaction partner of the transaction, in its role as a sender or recipient of coin data sets.

34. The coin managing unit according to claim 28, wherein the first and the second requirements are requirements for conditional transactions,
wherein requirements for conditional transactions contain a type of condition and/or a type of conditional transaction which is permissible for the coin managing unit.

35. The coin managing unit according to claim 34, wherein
the secure execution unit stores a conditional transaction when the requirements for conditional transactions are met; and/or
the secure execution unit executes a conditional, stored, transaction only when a condition is met, an additional transaction request is received for a transaction which falls under the stored conditional transaction, and/or
a conditional transaction comprises a temporal condition, an external triggering event as a condition and/or a security value as a condition.

36. The coin managing unit according to claim 28, wherein the first and the second requirements or an additional requirement is an amount requirement:
a maximum value for the amount of the coin data sets to be transmitted and/or for the amount of the coin data sets to be received, or
a maximum value or a minimum value for a total amount of coin data sets stored in the coin managing unit, or
a maximum value for a sum of transaction amounts of transactions executed within a time period.

37. The coin managing unit according to claim 28, wherein, furthermore, one or more of the following data elements are stored:
a unique coin managing unit identifier, and/or
a public coin managing unit key of an asymmetrical key pair; optionally a secret coin managing unit key of the asymmetrical key pair; and/or
a coin managing unit certificate, which comprises the coin deposit identifier and/or the public coin deposit key as certified content.

38. The coin managing unit according to claim 28, wherein at least one requirement is stored in a partially freely readable manner, the first or second requirement;
wherein a readable portion and a non-readable portion of the at least partially freely readable requirement are present; and
wherein the two portions are
stored in different data elements, or
stored in a common data element in a non-readable manner, and additionally the readable portion is stored in a separate freely readable data element.

39. The coin managing unit according to claim 28, wherein the first and/or the second requirement is a counter-performance requirement,
wherein the counter-performance is provided in response to at least one received coin data set as performance, in the response data to the sender of the received coin data set.

40. The coin managing unit according to claim 28, wherein the secure execution unit for managing the coin data sets
transmits transaction register data to a transaction register,
wherein the transaction register data comprise a unique transaction identifier, a transaction amount, a coin managing unit identifier of the sender, a coin managing unit identifier of the recipient, and the register reference of the coin data set in the coin register, and/or
transmits registration requests to the coin register, which comprises at least one register reference of a coin data set previously registered in the coin register and a register reference of a coin data set to be registered in the coin register.

41. The coin managing unit according to claim 28, wherein the coin managing unit
is a local coin managing unit, or
is a server-based coin managing unit, which either comprises its own secure execution unit for the user of the coin managing unit, or comprises a common secure execution unit for a plurality of users, in a coin deposit managing unit with coin deposits of the users.

42. The coin managing unit according to claim 28, wherein the secure execution unit, to manage the coin data sets in a transaction with an additional coin managing unit, evaluates a received data element of the additional coin managing unit,
wherein the additional data elements completely or partially comprise a requirement of the additional coin managing unit, and the secure execution unit checks the requirement of the additional coin managing unit for the transaction.

43. A method for outputting a new coin managing unit, which comprises a secure execution unit for managing digital coin data sets, for a user, comprising the steps of:
receiving a request for creating the new coin managing unit;
providing the new coin managing unit with stored data elements, wherein a secure execution unit is configured to check first and/or second requirements,
wherein the request comprises at least the first requirement,
the data elements stored in the providing step comprise the first requirement as a requirement data element,
the first requirement is an issuer requirement defined for the user, and
a second requirement that can be stored as a data element is provided for the same check criterion,
wherein the second requirement is either to be checked for a different exchange direction than the first requirement or can be selected after the provision step by the user as an increase of the first requirement.

44. The method according to claim 43, wherein additionally one or more of the following steps is performed:
checking an authentication contained in the request;
generating a coin managing unit identifier, which comprises a portion of a requirement, of the first requirement;
generating a coin managing unit key;
providing a coin managing unit certificate, which comprises a portion of a requirement or an additional portion of the requirement, of the first requirement.

45. The method according to claim 43, wherein the stored data elements comprise at least one coin data set;
wherein the secure execution unit, in order to manage digital coin data sets,
receives a coin data set for the new coin managing unit, and/or
transmits a registration request to a coin register of the central bank which, for a received previously registered coin data set, requests the registration of a coin data set to be stored in the new coin managing unit.

46. The method according to claim 43, wherein the request comprises a user for which the new coin managing unit is created; or
the new coin managing unit is created without a user assignment, and an assignment of the created new coin deposit to a user takes place in response to an assignment request.

47. The method according to claim 43, wherein the coin managing unit is a server-based coin managing unit which either comprises its own secure execution unit for the user of the coin managing unit or comprises a common secure execution unit for a plurality of users, in a coin deposit managing unit with coin deposits of the plurality of users.

48. A method for managing coin data sets in a coin managing unit comprising a secure execution unit and at least one coin data set, comprising the steps of:
receiving a transaction request;
reading data elements stored in the coin managing unit;
checking a first requirement and/or a second requirement;
executing a transaction or storing a conditional transaction that corresponds to the transaction request;
wherein the first requirement and the second requirement are stored in the coin managing unit as requirement data elements;
the first requirement and/or the second requirement are read in the step of reading; and
the first requirement and the second requirement pertain to the same check criterion,
wherein the first requirement is an issuer requirement and the second requirement is a user requirement and/or the first requirement is a receipt requirement and the second requirement is a transmission requirement.

49. The method according to claim 49, wherein the issuer requirement and the user requirement are direction requirements; and/or
the first requirement and the second requirement are requirements for conditional transactions, and/or
the first requirement and the second requirement are counter-performance requirements, and/or
the first requirement and the second requirement are amount requirements.

50. The method according to claim 48, wherein in the checking step for the transaction
a data element of the transaction request, a transaction amount or a transaction partner, and/or a data element of the coin managing unit is compared with the requirement; and/or
depending on the exchange direction of the transaction, the transmission requirement and/or the receipt requirement is checked; and/or
only the user requirement, which is narrower than the issuer requirement, is checked or the user requirement and the issuer requirement are checked; and/or
depending on the requested transaction, different requirements, a plurality of requirements for different data elements of the transaction or of the coin managing unit, are checked.

51. The method according to claim 48, wherein the transaction request is received by the user and the conditional transaction is stored as a conditional transaction released by the user; and/or
the conditional transaction is only temporarily stored during storage and is executed when a triggering condition is met, or when stored as a release frame of the user for later transaction requests of a third party, which is named as the recipient in the conditional transaction,
the transaction request or an additional transaction request from a third party is a triggering condition for a stored conditional transaction,
wherein either the temporarily stored conditional transaction is executed or a transaction requested by the third party is executed, which transaction falls under the stored conditional transaction released by the user.

52. The method according to claim 48, wherein the execution of the transaction, the requested or the conditional transaction, comprises:
transmitting or receiving a coin data set of the central bank, and/or
transmitting a registration request to a coin register of the central bank which, for a received previously registered coin data set, requests the registration of a coin data set to be stored in the new coin managing unit, and/or
transmitting transaction register data to a transaction register, and/or
providing a counter-performance, wherein the transaction request comprises a coin data set.
